(19) United States
(12) Patent Application Publication
(10) Pub. No.: US 2024/0127280 A1
(43) Pub. Date: Apr. 18, 2024

(54) SYSTEM AND METHOD FOR INCENTIVIZED ADVERTISEMENT VIEWING

(71) Applicants: Robert Alford, Richmond, TX (US); James Pinkston, Hockley, TX (US)

(72) Inventors: Robert Alford, Richmond, TX (US); James Pinkston, Hockley, TX (US)

(21) Appl. No.: 18/381,127

(22) Filed: Oct. 17, 2023

Related U.S. Application Data
(60) Provisional application No. 63/417,151, filed on Oct. 18, 2022.

(51) Int. Cl. G06Q 30/0208; G06Q 30/0242; G06Q 30/0251; G06Q 30/0272; H04W 4/23

(52) U.S. Cl. CPC G06Q 30/0208; G06Q 30/0245; G06Q 30/0257; G06Q 30/0272; H04W 4/23

(57) ABSTRACT

A system and method for displaying advertisements to a viewer. An advertiser may upload one or more advertisements to a server and select various parameters for displaying the advertisement to a viewer. A viewer may choose to view advertisements in return for compensation. The viewer may be asked to verify comprehension or provide feedback on the advertisements before compensation is awarded.

### CROSS-REFERENCE TO RELATED APPLICATION

This application claims priority to U.S. Provisional Application No. 63/417,151, which was filed on Oct. 18, 2022, which is incorporated by reference herein in its entirety.

### FIELD OF THE INVENTION

This disclosure relates generally to advertising. More specifically, it relates to a system and method for incentivized advertisement viewing.

### BACKGROUND

Advertising is an industry with a long history. Over the years, technology has changed the way advertisements are delivered—from printed advertisements to radio commercials to television commercials. One problem with these types of advertisements is that there is no guarantee that the advertisement is actually being viewed by the intended consumer. For example, viewers may leave the room during a television commercial break or may converse with others. Also, advertisements on these mediums cannot be customized for individual viewers, so advertisers must make generalities about the audience of a radio or TV ad. Further, these advertisements offer no direct means of assessing a viewer's opinion of the advertisements. Thus, it is difficult for advertisers to measure the success of their advertising dollars and ensure the efficient use of advertising budgets.

The rise of the internet and personal computing devices has changed the way advertisements are delivered to viewers. Advertisements can be directed to viewers by keywords used in a search or by the viewer's geographic location, age, etc. However, many of these advertisements still offer no guarantee that a viewer is actually paying attention as there is little to no incentive for the viewer to pay attention to the advertisement.

It would therefore be advantageous to have a system and method which avoids these and other drawbacks of existing systems and methods.

### SUMMARY OF THE INVENTION

A method and system for incentivized advertisement viewing, comprising: receiving, from an advertiser, advertisement media; storing, at a server, the advertising media received; receiving, from a viewer, a selection of a limit for a viewing session, the limit comprising a number of advertisements or a time limit; receiving, from a viewer, a category choice for which to display advertisements; sending advertising media to a viewer's device; pausing the advertisement video during playback; sending a first verification to the viewer's device; receiving, from the viewer, a first verification response; resuming the advertisement video playback; requesting a rating and comments from the viewer; receiving a rating selection from the viewer; sending a second verification to the viewer, the second verification comprising a code or link; receiving a second verification response from the viewer; and applying a reward to the viewer's reward bank.

### BRIEF DESCRIPTION OF THE DRAWINGS

FIG. 1 depicts a system for incentivized advertisement viewing according to one embodiment.

FIG. 2 depicts a flow chart of a method for incentivized advertisement viewing according to one embodiment.

### DETAILED DESCRIPTION

Traditional advertising methods make it difficult for an advertiser to make efficient use of advertising spending. There is no guarantee that the advertisement is being viewed, advertisers have little to no feedback on the viewer's opinion of the advertisement, and viewers do not receive any compensation for viewing a particular ad.

To solve these and other problems with existing advertising methods, a system and method for incentivizing advertisement viewing is provided herein.

For purposes of this disclosure, an “advertiser” or “client” is an entity that wishes to have its advertisements shown. A “user” or “viewer” is someone to whom the advertisement is presented.

Systems and methods for incentivized advertisement viewing provided herein can be used to optimize an advertiser's capital spent on advertising. Viewers can view advertisements on their device (computer, cell phone, tablet, etc.) and provide confirmation of viewing as well as feedback for the advertisement to advertisers. The viewer is compensated via rewards for each advertisement viewed and the rewards are stored in a rewards bank. Advertisers are ensured that their advertisements are being viewed and provide rewards to viewers. Viewers can earn rewards on their own time, at the gym, waiting in line, on public transportation, etc.

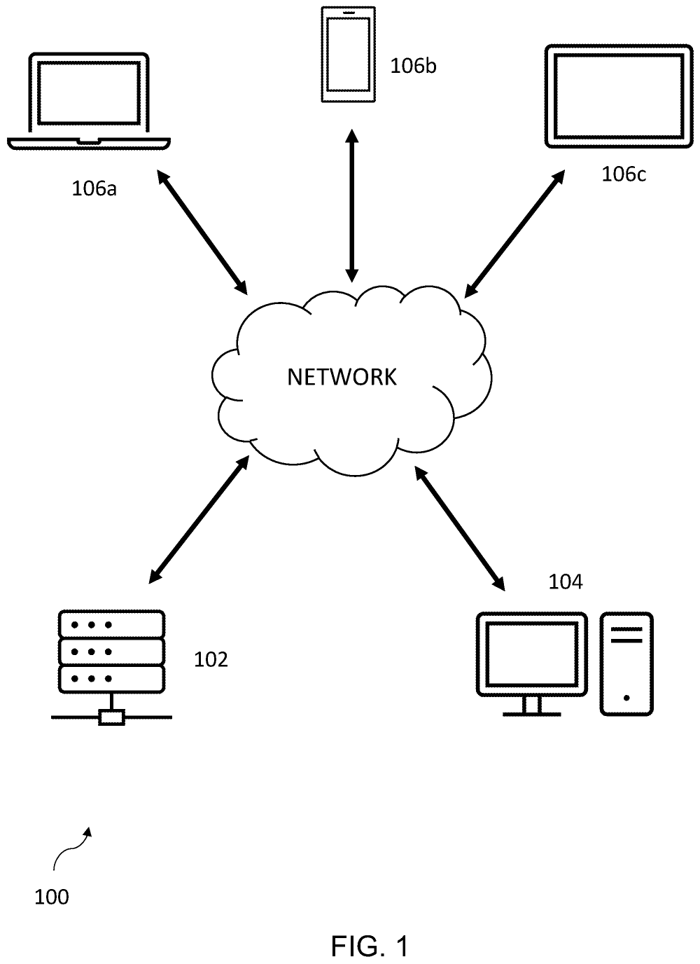

FIG. 1 depicts an overview of an incentivized advertising system 100. Advertising system 100 is comprised of a server 102 that is connectable to one or more advertiser terminals 104 and a plurality of viewer devices 106a, 106b, and 106c. The connection between the devices may be any means such as an internet connection. The server 102 receives and stores advertisement media such as videos from the one or more advertisers and sends the advertisement media to one or more viewer devices. Storage may be on the server itself or on a database connected to the server on a non-transitory computer readable medium. The server 102 also provides platforms for both the advertisers as well as the viewers. Platforms may be in the form of an app for a computer, tablet, or smartphone (i.e., Android, iOS, Mac, Windows, Linux operating system) and also in the form of a web app accessible via web browser.

The advertiser terminal 104 may be any device such as a personal computer capable of connecting to the server. The advertiser may set up an account by interacting with the advertiser platform via the advertiser terminal 104 and upload one or more pieces of advertising media. The advertiser may also use the advertiser terminal 104 to set parameters for running the advertisement.

Advertisement parameters can be ad duration time, start and end dates to run the advertisement, which categorie(s) the advertisement is to be run in, the form and quantity of rewards the viewer will receive for watching the advertisement, any extra incentives to offer to the viewer, and maximum amount to spend per advertisement campaign or per view. The advertiser may also select or write questions to be asked of the viewers for feedback.

Advertisers may also choose to limit advertisements to be shown to viewers within a specific geographic area. For example, a tour company or a local restaurant may show ads to viewers within 25 miles of the business location. In setting up the parameters for the advertisement, the advertiser may select an option to enable location-based advertisements as well as the location parameters for the advertisement. Location parameters may be defined by cities, states, countries, zip codes, area codes, radius from one or more defined locations, etc. The server may receive the election of location-based advertisement and location parameters from the advertiser terminal as well as a location from the viewer device and determine whether to display a particular advertisement to a viewer based on the viewer's location and advertisement location parameters.

A viewer's location may also be used to prompt a viewer that an advertisement is available. For example, a viewer comes in close proximity to a retail store and is prompted to watch an advertisement for that retail store. A notification may be displayed on the viewer's device that an advertisement from that particular retailer is available for viewing. Because the viewer is already near the store, they may be more likely to visit that store and make a purchase in response to an advertisement, thus making efficient use of advertising expenditures.

In addition to advertisement parameters received by an advertiser, the system may use artificial intelligence (AI) to decide when to prompt users as well as which advertisements to display to a viewer, or for any other function performed by the system.

The system may also compute and send viewing analytics to the advertiser. For example, the system may tally up the number of times a piece of advertising media has been presented to a viewer, the ratings given to each piece by the viewers, including a max, min, mean, and median rating, total amount spent, cost per view, viewer comments, etc.

A viewer wishing to view advertisements and receive rewards may access the viewer platform provided by server 102 via the viewer's device (e.g., 106a). The viewer may create an account or sign in to their account. The viewer may input certain information such as age, sex, location, and interests. The viewer may then select a category of products and services they would like to view advertisements for. The viewer then watches one or more advertisements in a viewing session. One or more verifications may be performed to ensure the viewer is paying attention to the advertisement and to prevent fraud.

One such verification that may be used is a first verification where the advertisement is paused and the first verification must be completed before resuming the video. The pause may happen at a specified time or may be random. The first verification may comprise a question that the viewer must answer before the remainder of the video is played. The question may be one that is relevant to the video in progress and is used to determine that the viewer is paying attention to the advertisement. The viewer must then answer the question before the remainder of the video is played and the reward is given. The verification may be given as a multiple-choice question in the form of words or pictures. The advertising system or advertiser may permit a certain number of incorrect answers per video or may have a certain number or percentage of missed guesses allowed per session before refusing to give the reward or ending the viewing session.

At the end of an advertisement, a second verification may be performed. The second verification may comprise a text message or email to verify the viewer's identity and also to verify that the viewer has seen the advertisement. Such verification may help prevent computer programs or “bots” from cheating the system. The text or email may provide a one-time password or link to click for verification. Additionally, the viewer may be presented with a prompt asking the viewer to rate the advertisement on one or more rating metrics and allow the viewer to write in comments. For example, the viewer may be asked to rate the advertisement on a scale of 1-5 overall, for humor, for clarity, etc. The ratings and comments provided by the user may then be stored in the server 102 for viewing by advertisers. Only after the viewer has viewed the advertisement, answered any required questions, and rated the advertisement, will the viewer's account be credited with the designated reward. The viewer may repeat the viewing process a number of times to build up rewards in a rewards bank. The rewards bank may store the reward balance until rewards are redeemed.

The rewards may be dispersed to the user in the form of a gift card, prepaid debit card, coupon code, cryptocurrency, etc. The viewer may choose the form in which the rewards are redeemed. The viewer may choose a cash reward, a gift card to a specific merchant, a gift card specific to an advertiser whose advertisements have been viewed, cash back at the point of sale, or they can be donated to charity. A minimum rewards balance may be required before disbursement is allowed, for example a cash amount of $10.00 USD. Rewards may be partially or fully redeemed and may be split among two or more forms or advertisers.

The advertiser may offer a different reward to the viewer who watched the advertiser's ads than if the viewer watched advertisements from other categories or companies. For example, a viewer may receive a higher amount of gift card for brand X if they have been watching advertisements of competitors to brand X. A clothing company may offer less of a reward if the clothing company's advertisement rewards are redeemed for electronics.

The viewer may also be presented a “buy now” option allowing a viewer to purchase a product shown in a recently watched advertisement or another product from the advertiser. The “buy now” option may appear during or after the advertisement and may allow the viewer to use rewards earned from that most recent view as well as rewards from the rewards bank. The “buy now” button may also include a limited-time promotion. For example, the reward may be doubled. The viewer may then be directed to the advertiser's website for purchase.

Using the advertising platform, a viewer may also sign in to view their rewards earned, the history of advertisements watched with dates and times, a list of advertisers for which advertisements have been viewed, rewards received per advertiser/category, rewards redeemed per advertiser/category, and total rewards available per advertiser. The list of advertisers and advertisements seen may also be automatically sent to the viewer via email on a specified basis (e.g., daily, weekly, after each viewing session).

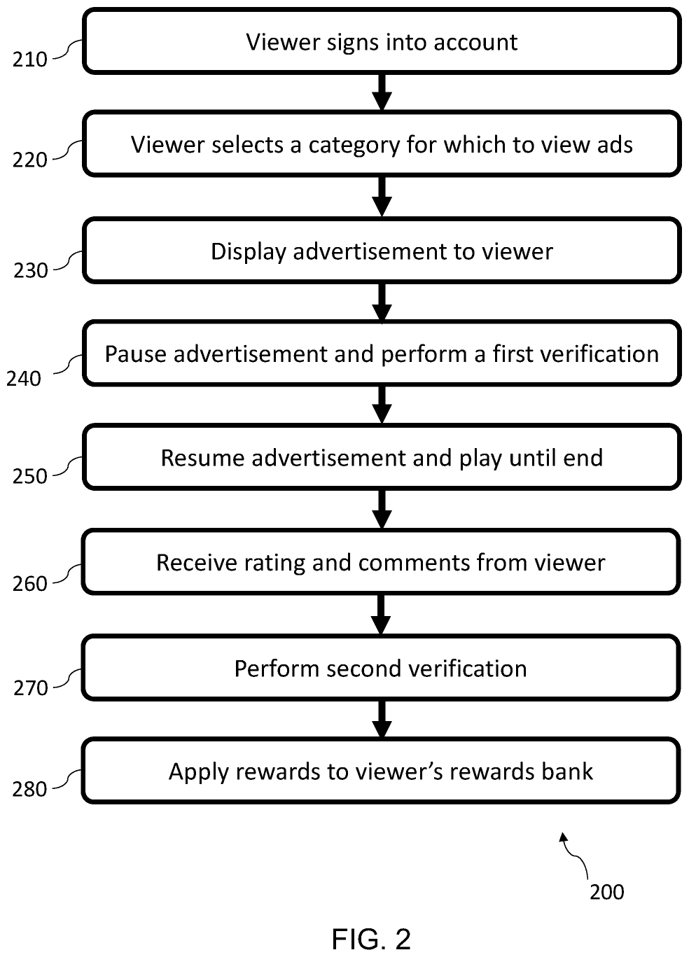

FIG. 2 depicts a flow chart of a method for incentivized advertisement viewing 200 according to one embodiment is shown. Depicted is a so-called viewing session which refers to a period where the user views one or more advertisements.

Before viewing advertisements or receiving rewards, the viewer may sign into their account 210. The viewer may select a limit for a viewing session or the system may limit a viewing session. The limit may be a certain number of advertisements or an amount of time. The viewer then picks a category for which they will watch advertisement videos to receive rewards 220. The categories may be organized into retail, food, entertainment, clothing, home improvement, charity, travel, etc. Each category may comprise many companies. The viewer then views advertisements from the selected category on the viewer's device 230. During the advertisement, the video is paused and a verification is performed such as asking a question to ensure the viewer is paying attention 240. After completing the verification, the video is resumed until the end 250. The user then rates the advertisement and provides comments 260. A second verification is performed 270. A confirmation banner is displayed on the viewer's device confirming that rewards have been added to the viewer's reward bank 280. A link may be provided to allow the user to visit the advertiser's website to purchase a product or receive an additional promotion.

It is contemplated that such an incentivized advertisement system and method could take many forms without departing from the spirit of the invention.

The discussion herein of the present invention is directed to various embodiments of the invention. The term “invention” is not intended to refer to any particular embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Herein, the terms “including,” “consisting of”, and “comprising” are used in an open-ended fashion, and thus should be interpreted to mean “including, but not limited to.” Also, the term “connect” or “connected” where used if at all is intended to mean either an indirect or direct connection. Thus, if a first component connects to a second component, that connection may be through a direct connection or through an indirect connection via other components and connections.

Certain terms are used throughout the description and claims to refer to particular system components and method steps. As one skilled in the art will appreciate, different companies may refer to a component by different names. This document does not intend to distinguish between components that differ in name but not function.

It is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of incentivized advertisement viewing, comprising:
receiving, from an advertiser, advertisement media;
storing, at a server, the advertising media received;
sending advertising media to a viewer's device;
pausing the advertisement video during playback;
sending a first verification to the viewer's device;
receiving, from the viewer, a first verification response;
resuming the advertisement video playback; and
applying a reward to the viewer's reward bank.

2. The method of claim 1, further comprising:
receiving, from a viewer, a selection of a limit for a viewing session, the limit comprising a number of advertisements or a time limit.

3. The method of claim 1, further comprising:
requesting a rating and comments from the viewer; and
receiving a rating selection from the viewer.

4. The method of claim 1, further comprising:
receiving, from a viewer, a category choice for which to display advertisements.

5. The method of claim 1, further comprising:
sending a second verification to the viewer, the second verification comprising a code or link; and
receiving a second verification response from the viewer.

6. A system for incentivizing advertisement viewing, comprising:
a server configured for:
receiving, from an advertiser, advertisement media;
storing, at a server, the advertising media received;
sending advertising media to a viewer's device;
pausing the advertisement video during playback;
sending a first verification to the viewer's device;
receiving, from the viewer, a first verification response;
resuming the advertisement video playback; and
applying a reward to the viewer's reward bank.

7. The system of claim 6, wherein the server is further configured for:
receiving, from a viewer, a selection of a limit for a viewing session, the limit comprising a number of advertisements or a time limit.

8. The method of claim 1, wherein the server is further configured for:
requesting a rating and comments from the viewer; and
receiving a rating selection from the viewer.

9. The method of claim 1, wherein the server is further configured for:
receiving, from a viewer, a category choice for which to display advertisements.

10. The method of claim 1, wherein the server is further configured for:
sending a second verification to the viewer, the second verification comprising a code or link; and
receiving a second verification response from the viewer.
